(19) United States
(12) Patent Application Publication
(10) Pub. No.: US 2009/0151663 A1
(43) Pub. Date: Jun. 18, 2009

(54) Two-stroke internal combustion engine with two opposed pistons per cylinder

(76) Inventor: Jose Enrique Pastor Alvarez, Mexico City (MX)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/362,564

(22) Filed: Jan. 30, 2009

Related U.S. Application Data
(63) Continuation-in-part of application No. PCT/MX2006/000083, filed on Jul. 31, 2006.

(51) Int. Cl. F02B 33/00

(52) U.S. Cl. 123/68; 123/65 PE

(57) ABSTRACT

A two-stroke engine to be cooled by air includes a cap and base forming a cylinder chamber, at least two cylinders having a wet liner, wherein said cylinders are housed in the cylinder chamber, wherein in said wet liner at least an admission port and at least an exhaust port and at least one vacuum valve and injector are found, a pair of found pistons within each cylinder, the pistons being adapted to move between a first position where the pistons are spaced and a second position where the pistons are proximate, at least one admission mean per cylinder connected to said cap, which admits gas to the cylinder interior by means of the admission port, at least one exhaust mean per cylinder connected to said base, which allows gas exhaust from the cylinder interior by means of the exhaust port. The admission port may be alternated in position with said exhaust port in each one of the cylinders and said admission means may be alternated in position with said exhaust means in each one of the cylinders. The wet liner is cooled by the admission of fresh and clean gas to the cylinder interior.

### CROSS-REFERENCE TO RELATED APPLICATION

This application is a continuation-in-part application of and claims priority under 35 U.S.C. §§ 120 and 363 to PCT/MX2006/000083, filed Jul. 31, 2006, the contents of which is hereby incorporated by reference in its entirety.

### TECHNICAL FIELD OF THE INVENTION

This invention refers to vehicle engines, specifically, this invention refers to two-stroke engines for ground, air or industrial vehicles, wherein the engines may be of a different number of cylinders, for use with gas, gasoline, diesel, hydrogen, etc.

### DESCRIPTION OF PREVIOUS TECHNIQUES

Two-stroke internal combustion engines differ from the more common four-stoke engines, in that they complete the same four processes—admission, compression, expansion and exhaust—in two linear piston movements, that is, one turn of the crankshaft. This is accomplished using first the compression stroke and the end of the expansion stroke, to perform the gas admission and exhaust functions. This allows an expansion stroke for each crankshaft revolution, instead of the second revolution, as occurs in four-stroke engines. Therefore, two-stroke engines supply high specific power, thus said two-stroke engines being valued in industrial applications.

The usual features of a two-stroke engine, in comparison to a four-stroke engine, are: (1) both sides of the piston perform a simultaneously function in a two-stroke engine, in comparison to a four-stroke engine, wherein only the upper side is active; (2) in a two-stroke engine, the gas admission and exhaustion to the engine is done through ports, these being orifices situated in the cylinder; (3) a two-stroke engine lacks the valves which open and close gas flow in four-stroke engines; (4) in a two-stroke engine, the piston, depending on the position it occupies in a cylinder at a determined moment, opens or closes gas flow through the ports; (5) in a two-stroke engine, the crankshaft crankcase has to be sealed and has the function of a pre-compression chamber, compared to a four-stroke engine, wherein the crankcase serves as a lubricant deposit; (6) finally, in a two-stroke engine, lubrication is attained by mixing oil with fuel, in a proportion capable of varying, whereas a four-stroke engine, lubrication is done by means of the crankcase.

A feature of two-stroke engines already known in the state of the art is interchanging gases in the combustion chamber using a gas fluid under pressure supplied by a blower with helicoidal rotors. The gas fluid under pressure enters through the admission port or ports, which are orifices in the cylinder wet liner, located in the liner wall perimeter in the place known as lower dead center. The pressurized fluid causes a combustion gas sweep towards the chamber exterior through second orifices located at the head of the motor. Said orifices located at the motor head, allow the valves to settle and consequently, they permit the valves to remain closed starting from and during the compression sweep, until the end of the strength run to open up later, allowing the exhaust sweeping of the combustion gas.

The alternative movements in the two-stroke engine cylinders known in state of the art, which carry out the four exhaust valves per cylinder to open or close, are due to cam action which when rotating, pushes and compresses its four coils with the valves, uncovering the ports. The cubic or cylindrical capacity of the chamber, is the gas volume capacity allowed within the cylinder between the displacement space that the piston leaves, in view of a head fixed position from the upper dead center to the lower dead center, therefore, the power supplied by an engine depends both on the fuel energy used, as well as on the amount of gas admitted inside the chamber or cubic capacity, as well as the high compression relationship resulting from the design of revolutions per minute.

Documents disclosing two-stroke engines with the aforementioned features are known from the state of the art. For example, British patent number 510,542 discloses a direct injection symmetric two-stroke internal combustion engine, made up by two axially opposed pistons per cylinder, with two port sets, wherein each set has two ports which are distributed on the walls of the liner at the lateral dead center, fed by pressurized air through compressors—alternative, centrifugal or axial—and with a synchronized sweeping of the exhaust gases, from the admission port set to the exhaust port set produced by the crankshaft synchrony associated to each cylinder through mesh gears.

Different to the present invention, the aforementioned patent shows a two-stroke engine wherein half a block of pistons are used as air compressor elements. Therefore, in view that half a block of pistons and their corresponding parts have to be in motion, the engines yield is affected and reduced due to weight excess, as well as friction excess.

British patent number 584,783 discloses a two-stroke internal combustion engine having a plurality of cylinders with open ends. Each cylinder contains two opposed pistons, which during their reciprocity towards and against each other, cover and uncover the ports, which may be considered as admission and exhaust orifices. The opposed pistons are coupled by means of connecting rods to the crankshafts, which are coupled together and to an exit, by a set of helicoidal rotors including rotors in the crankshafts. Said patent shows the pistons body axially found per cylinder, as well as the ports and the crankshafts, however, contrary to the present invention, the document does not disclose how the necessary pressurized air fluid circulation is generated to cause the gas sweeping within the chamber. Therefore said patent discloses an engine which is partially unprovided by a air pump.

U.S. Pat. No. 3,386,424 discloses a two-stroke internal combustion engine showing tow identical cylindrical block heads, two identical interchangeable cylindrical blocks, found in a center crankshaft and in opposed angles of 180°; said cylindrical blocks are die to provide six cylinders per block, wherein all are open in both ends. Said six cylinders per block are made up of two pairs of power cylinders and tow service cylinders of lesser diameter vertically centered between each pair of power cylinders to form two pairs of three cylinders in each block. In the above-mentioned patent, it is not disclosed that the pistons are found per cylinder. Furthermore, said patent discloses that the air feed is done by a tri-lobular rotating compressor.

U.S. Pat. No. 6,182,619 discloses two-stroke, opposed piston, engine, including a motor block enclosing a cylinder assembly and retaining the components of the assembly together. The engine block also includes a body block separating a pair of opposed end caps held together by four spaced locks, extending between the end caps. Furthermore, each end cap includes an end pate providing access to the cylinder assembly. The number of cylinder assembly incorporated to the engine, may be varied according to the engine required power. A plurality of ports are circumferentially oriented in a cylindrical housing, wherein the ports extend substantially transversal through each cylinder wall, releasing exhaust fluid from the cylinder chamber. The ports are positioned surrounding a cylindrical housing circumference in the exhaust section of a cylindrical housing. Likewise, a plurality of admission ports are positioned surrounding the cylindrical housing in the entry section. To direct the pressurized gas towards the cylindrical chamber, the admission ports may be connected to a collector, which is connected to an admission pump to provide a pressurized fluid to the chamber through the admission ports. The pistons are substantially opposed and positioned within a cylindrical chamber. The pistons are coupled through a connecting rod to a crankshaft. The pistons are adapted to be moved between a first position in which the pistons spaced apart and a second position in which the pistons are proximate each other. If recognized that the movement of the first piston within the cylindrical chamber selectively opens and closes the exhaust ports, the movement of the second piston within the cylindrical chamber selectively opens and closes the admission ports. The above mentioned patent do not show water galleys for cooling systems in regards to the wet liner, and therefore seals required between the air galleys, contrary to the present invention, wherein the seals are represented by two different diameters, wherein the greater diameter corresponds to the toroidal escape and the lesser diameter to the toroidal admission.

Additionally U.S. Pat. No. 6,182,619 does not show a vacuum check valve through which the pistons may not be initially separated as shown in FIG. 3 of said patent, thus forming a pneumatic lock which does not allow the crankshaft to rotate and thus does not allow a correct use of the invention. The patent does not show an oil tub communication between both tubs. Additionally, the patent does not show the necessary and indispensable air pump to feed the compression chamber to carry out the gas circulation sweep between the corresponding inlet and outlet ports. The liners shown in said patent are not interchangeable or wet. In light of the injector body size shown in said patent, the injector is mechanical and not hydraulic. The coupling of the bodies that constitute past mono-blocks from one bed plate to the other. Finally, a further difference between the present invention and the above-mentioned patent is that the synchronization mechanism of the crankshaft is not disclosed by said patent.

Therefore, a two-stroke engine capable of increasing cubic chamber capacity is required, which at the same time increases compression relation and eliminates tension resistance from the coils and valves, cooling the cylinder wet liner at the same time, in an automatic manner during each cycle.

### BRIEF DESCRIPTION OF THE INVENTION

The present invention contemplates a direct-injection two-stroke internal combustion symmetric chamber, which includes two axially opposed pistons in each cylinder, wherein the pistons are specially conditioned with a couple of sets of ports. The chamber is a bi-block formed by a cap and a base, wherein the cap and base for the block. The bi-block of inline cylinders with ports, is disposed in such a manner that the pistons are opposed, that is, one piston in front of the other piston, and since each one of the cylinders are found in a horizontal position, the two pistons are aligned horizontally and axially found within the cylinder.

The port sets are distributed in an opposed manner between themselves, throughout the cylinder wet liner. Furthermore, the port sets are aligned with regards to the wet liner, that is, a first port set is aligned with the admission means, whereas the second port set is aligned with the exhaust port sets. As a consequence, the injection mouths are aligned with the respective intakes of the injectors. The symmetrical chamber allows the forced aspiration of pressurized gas by means of a helicoidal rotor blower. Therefore, the ports assist the chamber in forced aspiration of the pressurized gas, allowing a synchronized sweep of the combustion gas, from the admission port set to the exhaust port set.

The distribution of both port sets captures a double gas volume per stroke unit in the interior of each combustion chamber, increasing the compression relation, eliminating resistance and eliminating valve mechanisms and springs used in conventional engines.

The axially found pistons are within the cylinder wet liner. A common space between each axially found piston is formed. The common space and the cylinder walls, form the internal combustion chamber. The temperature of the gases within the combustion chamber and fuel injection, create combustion by the ignition within the chamber.

The axially found pistons per cylinder, are capable of displacing in both alternative senses within the liner. While displacing, the pistons determine two different positions, a first position being a lateral dead center and a second position being a central dead center. In the first position, that is in the lateral dead center, a gas sweep is carried out, which refers to the simultaneous gas admission and exhaust. In the second position, that is in the central dead center, gas compression and injected fuel ignition is carried out. When carrying out the gas compression and fuel ignition, that is, when the piston is in the second position, the piston is capable of returning to a first position completing the run of the piston and thus completing a two-stroke combustion cycle.

To create a temperature balance between the ports and the cylinders, the ports are alternated in the cylinders. That is, while in the first cylinder the admission and exhaust ports will be working as admission and exhaust ports respectively, in the second cylinder the admission and exhaust ports will be switched, that is, the admission ports will function as exhaust ports, whereas the exhaust ports will function as admission ports. When the cylinder ports are alternated, the admission means and the exhaust means are also alternated depending on the cylinder, thus heat is distributed, which is irradiated to the environment by conversion, when having the surface area of the bi-block cap exposed.

Therefore, in the main aspect of the invention, a two-stroke engine to be cooled by air, comprising a cap and base forming a cylinder chamber; at least two cylinders having a wet liner, wherein said cylinders are housed in the cylinder chamber, wherein in said wet liner at least an admission port and at least an exhaust port are found; a pair of found pistons within each cylinder, the pistons being adapted to move between a first position where the pistons are spaced and a second position where the pistons are proximate; at least one admission mean per cylinder connected to said cap, which admits gas to the cylinder interior by means of the admission port; at least one exhaust mean per cylinder connected to said base, which allows gas exhaust from the cylinder interior by means of the exhaust port; and wherein said admission port alternates position with said exhaust port in each one of the cylinders and said admission means alternates position with said exhaust means in each one of the cylinders is provided.

Therefore, an object of the present invention is providing a two-stroke engine capable of increasing cubic capacity of the combustion chamber.

Another object of the present invention is providing an two-stroke engine capable of increasing the compression relation.

A further object of the present invention is eliminating the tension resistance of the coils and valves.

Another object of the present invention is providing an engine capable of complying with the above objects and keeping the cylinders a temperatures substantially less to those known from the art.

A further object of the invention is providing an engine having less weight to those known from the art.

A further object of the invention is providing an engine capable of reducing kinetic within itself.

In view of the two afore objects, it is a further object to provide an engine which reduces pollution emission, taking into account the power, and yielding an advantageous relation of weight/power.

Other objects and advantages of the present invention will become apparent when taking into reference the description in combination with the following figures.

### BRIEF DESCRIPTION OF THE FIGURES

The particular features and advantages of the invention, as well as other objects of the invention, will become apparent from the following specification, taken into account with the following figures, which:

FIG. 1 is a front cross-section view of the internal combustion symmetrical chamber.

FIG. 2 is a front cross-section exploded view of the internal combustion symmetrical chamber.

FIG. 3 is an upper view of an engine using the internal combustion symmetrical chamber of the present invention.

FIG. 4 is a right lateral view of a partially exploded longitudinal cut of an engine using the internal combustion symmetrical chamber of the present invention.

FIG. 5 is a back view of an engine using the internal combustion symmetrical chamber of the present invention.

FIG. 6 is an upper view of the engine using the internal combustion symmetrical chamber of the present invention.

FIG. 7 is a lower view of the engine using the internal combustion symmetrical chamber of the present invention.

### DETAILED DESCRIPTION OF THE INVENTION

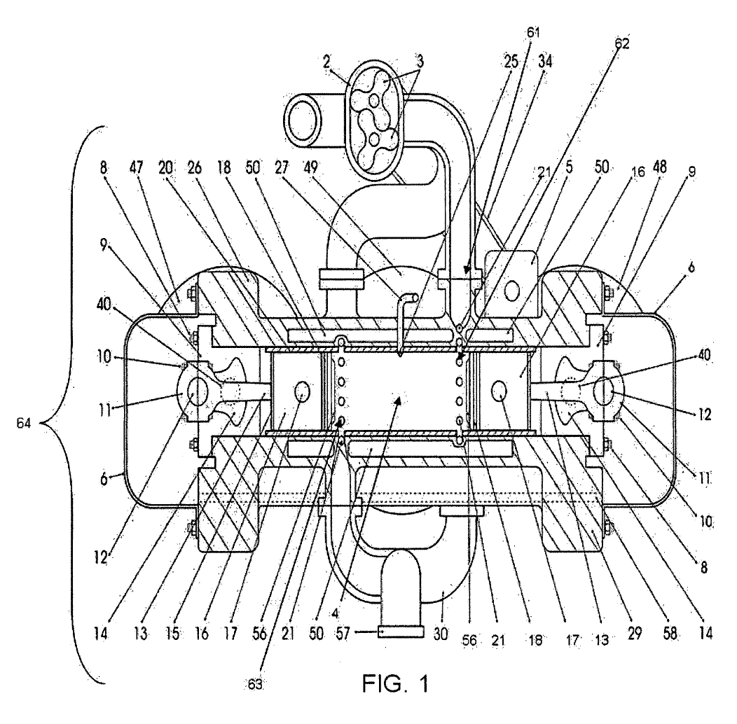

FIG. 1 is a cut-section front view of a two-stroke internal combustion symmetrical chamber (1), with multiple admission (52) and exhaust (53) means integrated to the same. The symmetrical chamber (1) is made up by a cap (26) and a base (29), wherein the cap (26) is similar to the base (29). The cap (26) and the base (29) are joined by means of vertical bolts (39), as well as by oil tub (6) to chamber (1) fastening means. Wherein a first part of the tub (6) is fastened to the cap (26) by means of lateral bolts (8), and a second part of the tub (6) is fastened to the base (29) by means of lateral bolts (8). The shaft (9) bolts are also capable of fastening the cap (26) and base (29) of the bi-block.

Between the cap (26) and base (29), the cylinder (4) liner (20) is found, also called wet cylinder (20), wherein a part of the cylinder (4) liner (20) is in contact with the cap (26) and another part of the cylinder (4) liner (20) is in contact with the base (29).

The cap (26) is a rectangular shape and in the intermediate part of the cap, a valley of less size than the rest of the rectangle. Since it is essentially the same than the cap (26), the base (29) is also of rectangular shape with a valley of less height than the rest of the rectangle.

The cap (26) is found coupled directly with the gas admission (60), by means of the blower (2) or compressor, as well as by the multiple admission means (52). The gas entry (60) transports a certain gas volume. When flowing through the compressor (2), the gas volume is reduced by means of rotors (3), which are preferably, however not limited to helicoidal trilobular rotors, thus increasing the pressure and the gas temperature. Therefore, when reaching the multiple admission means (52), the gas is pressurized, and keeps the pressure throughout its course by the multiple admission means (52). The multiple admission means (52) are coupled directly with the symmetrical chamber (1) cap (26) admission mouths (61), wherein the admission mouths (61) are found in the cap (26) valley. The symmetrical chamber (1) allows forced aspiration of the pressurized gas.

When ending the gas course or flow within the symmetrical chamber (1), and in view of the gas exhaust, the base (29) is directly coupled with the engine exhaust (30) by means of multiple exhaust means (30). The engine exhaust (30) gives exhaust to the interchanged gases in the combustion symmetrical chamber (1), by means of the mouth (57) of the engine exhaust (30), wherein the exhaust mouths (57) are found in the base (29) valley.

In both cylinder (4) ends and enclosed by the cap (26), base (29) and oil tubs (6), the shafts (11), crankpin (12) and connecting rods (13) are found, as well as the crankshaft (40). In both cylinder (4) ends, pistons (16) are found which are directly coupled to the connecting rods (13) by means of connecting rod bolts (17) in the central part of the pistons (16). Between the joint of the connecting rods (13) and bolts (17), seals are found, which are capable of abstaining the gas and liquid exhaust. The connecting rods are coupled to the crankshaft crankpin (12), which is fastened by its caps or shafts (11), by means of bolts (10). In view of this disposition, both pistons (16) within the cylinder (4) are axially opposed. The shaft (11), crankshaft crankpin (12) and connecting rods (13) movement which also moves the crankshaft (40) is transmitted to the pistons (16). The pistons (16) are adapted to move between a first position in which the pistons (16) are spaced apart and a second position in which the pistons (16) are proximate each other. When the pistons (16) are in a first position, it may be seen that throughout the cylinder (4) liner (20) radius, two sets of orifices are found, called ports (21).

In the tail of each one of the pistons (16) a compression flow ring (15) is found. In the head of each of the pistons (16), a fire ring (18) and chisel (56). The fire ring (18), the chisel (56) and the flow ring (15) are coupled to the piston (16) to direct with speed the gas towards the exhaust means (53) and consequently towards the motor exhaust (30).

The ports (21) are divided into two sets, a first port set are the admission ports (62) and a second port set are the exhaust ports (63). Both port sets (21) form an air galley. Both port sets (21) are distributed in an opposed manner between themselves, throughout the length of the cylinder (4) liner (20) radius. Additionally, both port sets (21) are aligned in regards to the cylinder (4) wet liner (20), that is, the first port set (62) is aligned with the admission means (52), whereas the second port set (63) is aligned with the exhaust means (53). Consequently, the injector (25) mouths (27) and respective injector (25) intakes, are aligned with regards to the cylinder (4).

The ports (21) assist the chamber (1) in the forced aspiration of the pressurized gas, wherein the ports (21) allow a synchronized sweep of the combustion gas, from the admission port set (62) to the exhaust port set (63). The distribution of both port sets (62, 63), form the air galley (21), capturing the double gas volume per stroke unit in the interior of each combustion chamber (1), increasing the compression relation and eliminating resistance of the valve mechanisms and coils used in conventional engines.

Both port sets (62, 63) are found distributed throughout the radius of the cylinder (4) wet liner (20), forming the symmetrical combustion chamber (1) air galley (21), thus allowing a cylinder (4) to be next to the following cylinder (4). The gas admission position through the ports (62, 63) is alternating, depending on the multiple admission means (52) and the multiple exhaust means (53), thus the admission ports (62) for the first cylinder (4) are found in a first determined side, whereas the admission ports (62) for the second cylinder (4) are found in a second determined side, wherein the second determined side is opposed to the first determined side. The admission ports (62) for the third cylinder (4) are found in said first determined side, whereas the admission ports (62) for the fourth cylinder (4) are found in the second side. It should be clear, that in view that the admission ports (62) are alternating, the exhaust ports (63) are also alternating. This port distribution (62, 63) is successive and depends on the number of cylinders (4) the engine (64) has. This alternation between the port (62, 63) position balances the temperature of the chamber (1) in general, and specifically the bi-block cap (26).

The gas course or flow within the symmetrical chamber (1) will be explained more precisely in the following lines. When displacing, the pistons (16) determine two different positions, a first position being the lateral dead center (LDC) which is a position wherein the pistons (16) are spaced apart between themselves, and a second position being central dead center (CDC) which is a position wherein the pistons (16) are proximate between themselves. In the first position, that is when the pistons (16) are in a LDC state, the gas sweep is carried out, which refers to the simultaneous gas admission and exhaust. In the second position, that is when the pistons (16) are in a CDC state, gas compression and injected fuel ignition is carried out. When carrying out gas compression and injected fuel ignition, that is, when the piston (16) is in a CDC state, the piston (16) is capable of returning to the first position completing the piston run, thus completing a combustion cycle. In a CDC state, a common space between each piston (16) exists. The common spate and the cylinder (4) liner (20), form the internal combustion chamber. In a LDC state, the common space between each piston (16) is greater than when the pistons are in a CDC state.

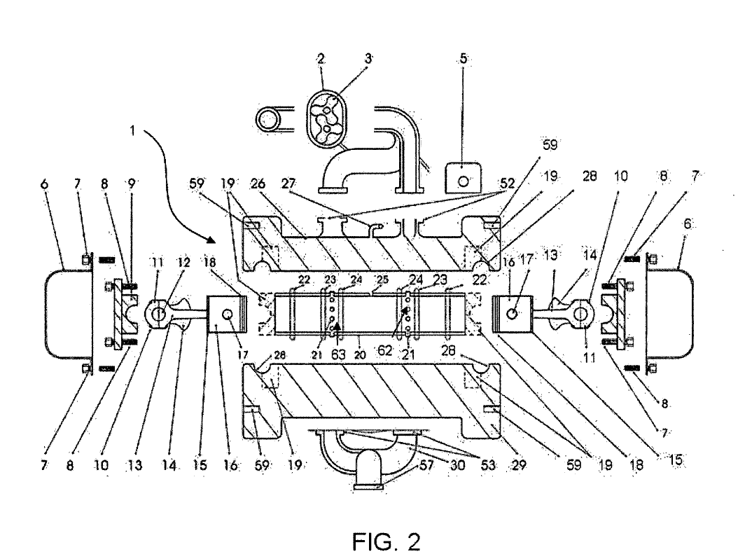

FIG. 2 is an exploded front view of the cross-section of the two-stroke internal combustion symmetrical chamber (1), with multiple admission (52) and exhaust (53) means integrated to the same. In the gas intakes (60) tubing is seen that directs a determined gas volume, the gas, later on, when passing through the blower (2) and rotors (3), changes its volume, changing to a greater pressure and temperature than previously, before being directed to the admission means (52).

The gas is admitted to the cylinder (4) by means of admission ports (62) in an LDC state, carrying out gas sweep, wherein said gas is admitted and exhausted simultaneously. In a CDC state gas compression and fuel injection ignition is carried out within the combustion chamber that is formed by the space between the two pistons (16). The LDC and CDC state is formed by the movement of the pistons (16) due to the crankshaft (40), shaft (11), crankpin (12) and connecting rod (13) movement.

The crankpin (12), connecting rod (13) and piston (16) are coupled laterally to the symmetrical chamber (1) by means of tub (6) shaft (9) lateral bolts (8) of the cap (26) and base (29) and consequently by means of bolts (7) of the tubs (6) of the cap (26) and base (29), as well as bolts (10) in the shafts (11). Additionally, joints may be placed (not illustrated). In each one of the symmetrical chamber (1) ends, a tub (6) is coupled by means of respective bolts (7)as well as orifices (59) formed in the cap (26) and base (29) respectively.

The connecting rods (13) have an internal lubrication vein (not shown) throughout the body of the connecting rod (13), wherein the vein lubricates the connecting rod bolt (17). Additionally, the connecting rod (13) has a nozzle in the connecting rod (13) end, wherein the nozzle sprays with oil the piston (16) interior housing, to constantly cool the piston (16) housing, wherein the oil comes from the tubs (6).

The piston (16) is coupled and inserted in the cylinder (4) interior, so that the piston (16) and rings (18, 15) are capable of sealing the cylinder (4) ends towards the respective shafts (11), crankpins (12) and connecting rods (13)m however the piston (16) is also capable of finding itself in a movement relation with regards to the cylinder (4). Since the pistons (16) are found in opposed sides of the cylinder (4), the pistons (16) are in axially opposed relations.

The cylinder (4), throughout the exterior of its wet liner (20), is surrounded by a plurality of seals (22, 23, 24). The plurality of seals (22, 23, 24) of the binding type, separates the water chamber (50) from the air galley (21). Likewise, the plurality of seals (22, 23, 24) separates the air galley (21) from the oil section of the tubs (6). Finally, the plurality of seals (22, 23, 24) separates the oil section of tubs (6) from the water chamber (50). Therefore, water, oil and gas mixture and the combination thereof is prevented.

Proximate to the cap (26), a pump body (5) installation is found. The pump body (5) is constituted by three different pumps (5), a first oil gear pump, a second water pump and a third fuel injection pump. Preferably the pump set (5) is hydraulic.

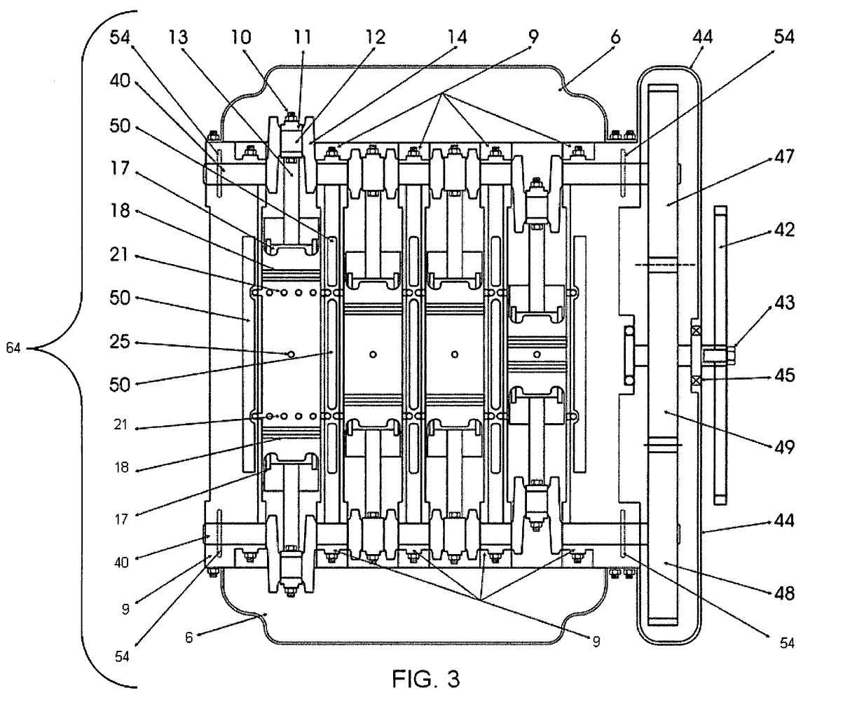

FIG. 3 is an upper view of the engine (64) using the internal combustion symmetrical chamber (1). In the right part of the figure the inertia wheel (42), the gear housing (44) with its respective gears (47, 48) in the inner part, the tubs (6) covering lie a housing the inner part of the engine (64) may be seen. It is important to note the relation shown between the shafts (11), crankpins (12) and connecting rod (13) shown in the figure, with the cylinder (4) and air galley (21).

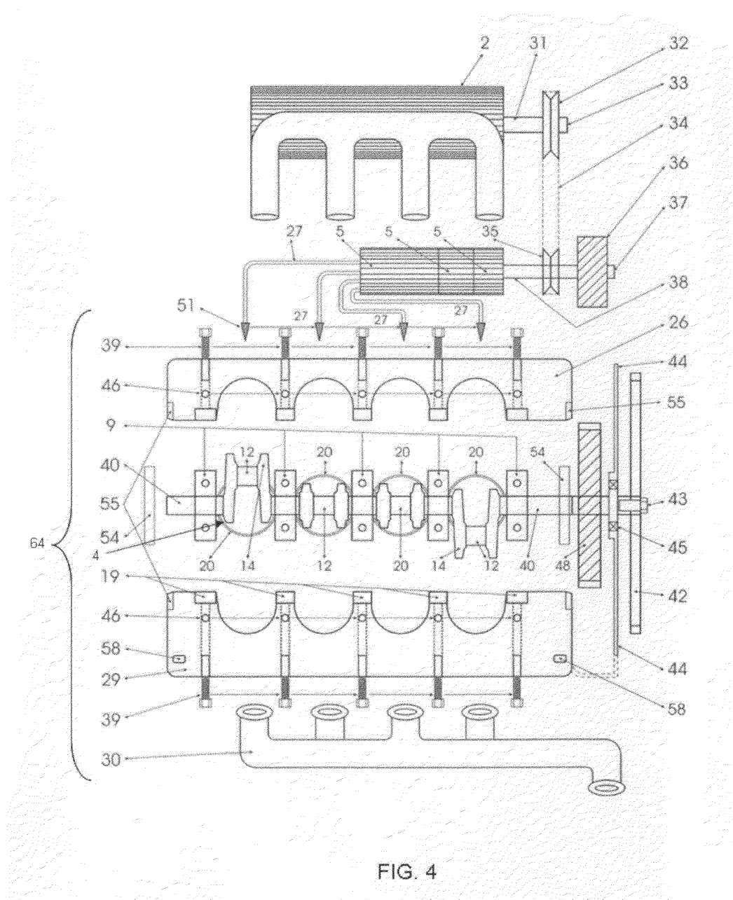

FIG. 4 is a right lateral view of a longitudinal cut partially in explosion of an engine using the internal combustion symmetrical chamber (1). As seen in the figure, the base (29) and cap (26) are joined by vertical bolts (39). In the exemplary case of FIG. 4, a four cylinder (4) engine is shown, using the two-stroke horizontal internal combustion symmetrical chambers (1) of the present invention. As seen in the figure, the cap (26) and base (29), when coupled and enclosing the cylinders (4), form a cylinder (4) bed plate (19).

In the left part of the chamber (1) the boxes (55) to hold oil are seen, in the half-sections of the bed plate (19), that is, in the cap (26) and base (29), as well as the oil holding (54) between the cap (26) and base (29). The vertical bolts (39), as well as the bores (46) fasten the cap (26) and base (29).

The oil drainage passages (58) are transversally communicated from an oil tub (6) to the other oil tub (6), where the tubs (6) as shown in the afore figures, are in the opposing sides. The drainage passages (58) may give place to a possible external lubrication circuit.

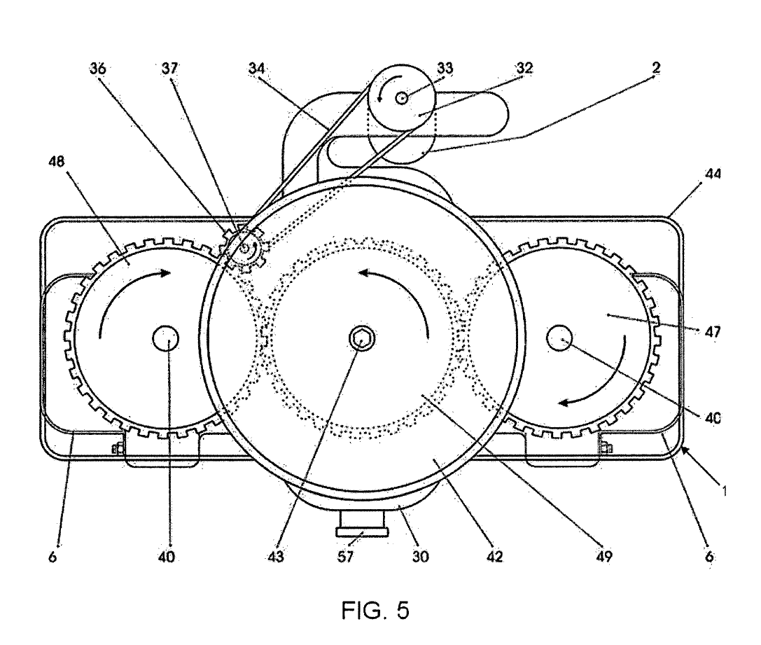

The central part of the figure in question, crankshaft (40) is found, as well as the crankpin (12) and the cylinders (4). In the right side a first crankshaft gear (48) may be seen, as well as the gear housing (44), the central gear oil retention (45), the inertia wheel (42), a security nut (42) of the inertia wheel (42), which will be explained with greater detail for FIG. 5.

Likewise, in the internal central part of the cap (26) and base (29), a plurality of internal basins in which the cylinders (4) will be housed in, are found. The basins have a semi-cylindrical shape. The cap (26) basins, are capable of being joined with the base (29) basins, so that when the cap (26) basins are joined with the base (29) basins, a cylinder shape is formed, which is capable of housing said cylinders (4). When the basins are joined, a chamber for the cylinders (4) is formed. This, i.e. the size of the basins, is another determining factor for the cubic or cylindrical capacity of the symmetrical chamber (1).

Between each one of the cylinder (4) wet liners (20), shaft bearing (9) are found, which allow keeping an appropriate separation between each of the cylinder (4) wet liners (20). The crankshaft counterweights (14) allow the correct movement of the pistons (16).

In the upper part of FIG. 4, the relation between the multiple admission means (52) and blower (2) may be appreciated. The blower (2) is constituted by the blower shaft (31), wherein the blower shaft (31) has a pulley (32), which is coupled to a power intake gear (36) which has a power transmission pulley (35), by means of a belt (34). The blower shaft (31) is coupled to the system by means of a security nut (33). The pumps are driven by the drive shaft (38), which is rotated by the blower (2) power intake gear (36). The drive shaft (38) is coupled to the system by means of a security nut (37). As stated before, the pump body (5) is made up of three different pumps, a first oil gear pump, a second water pump, and a fuel injection pump. As stated before, it is preferable that the pump body (5) be hydraulic and not mechanical, however, may not be limited only to hydraulic functioning.

The fuel is injected to each of the cylinders (4) through an injection line means, that directs the fuel flow from the fuel injection pump to each cylinder in a relation of 1-N.

FIG. 5 is a back view of an engine (44) using the two-stroke horizontal internal combustion symmetrical chambers (1). In the figure, the crankshaft (40) gear (47, 48) distribution may be seen with regards to the central synchronization gear (49), as well as the power intake gear (36) that drives the pump body (5), the power transmission pulley (35), the belt (34) and consequently the blower shaft (31) pulley (32). Even though not illustrated, a fifth gear for the alternator power intake, air conditioner, hydraulic direction, engine start, transference accessories, etc. may be necessary. The gears (36, 48, 47, 49) are found within the gear housing (44). Each one of the gears (36, 48, 47, 49) is coupled to the system by means of a nut in its central part.

The power caused by the blower (2) shaft (31) rotation is transmitted by means of the pulley (32) and belt (34) to the power pulley transmission (35), coupled with the pump (5) drive shaft (38). In an end of the drive shaft (38), the power intake gear (36) is found, which when rotating in a first sense, causes the crankshaft (40) first gear (48) to rotate in a second sense opposite to the first sense, by means of the existing gearing between the power intake gear (36) and the first gear (48). The synchronization gear (49), which is found geared with the first gear (48), rotates when the first gear (48) rotates, in the same first sense than the power intake gear (36). When the synchronization gear (49) rotates, the crankshaft (40) second gear (47) rotates in the same second sense than the crankshaft (40) first gear (48). Therefore the power transmission coming from the belt (34), causes the crankshaft gears (47, 48) to cause the piston (16) movement in the same sense, and therefore, causing the gas admission and exhaust in the chamber (1). The inertia wheel (42) is used to accumulate and change the angular inertia of the system.

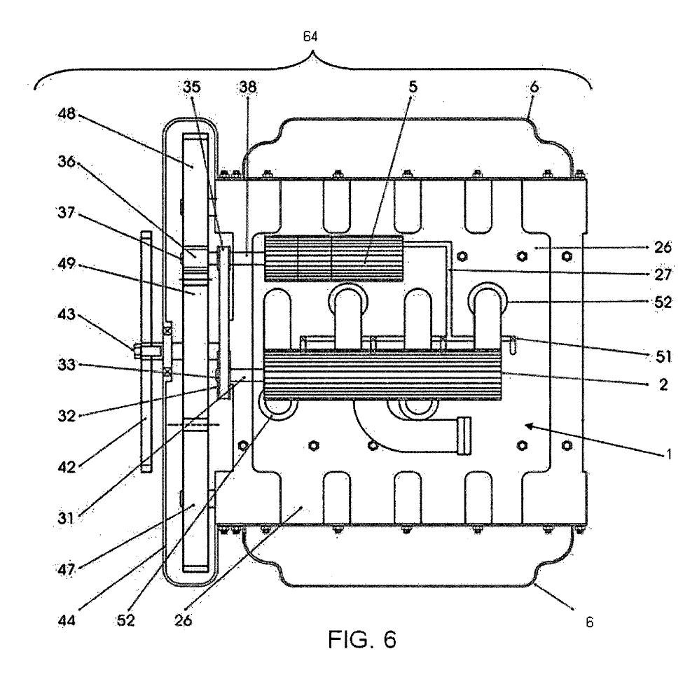

FIG. 6 is the upper view of the symmetrical chamber (1) engine (64) of the present invention, in which a four cylinder exemplary engine is seen. Likewise, the four multiple admission means (52) is seen, in light of the exemplary four cylinder engine, wherein the means (52) are alternating. In the figure, the cap (26) may be seen. The injector body (25) is also shown, as well as the fuel or intake injection tubing (27). As stated before, the distribution form of the pump (5) in regards to the intakes (27) is 1 to N, wherein a single intake (27) per cylinder (4) connected to the fuel pump (5), and depending on the cylinder (4) numbers of the engine (64), the greater number of intakes (27) there will be, consequently the same number of injectors (25). The phenomenon may be present when the engine (64) remains without functioning for certain time periods and the gas volume confined within the piston (16) heads escapes. The injector intake or vacuum check valve (27) is located in the injector liner (25) and is physically connected in the injector nozzle (25) and the cap (26) valley. The injector intake or check valve (27) allows the access of an absorbed quantity of gas from the exterior, by vacuum effect exercised between the pistons, when these change from CDC to LDC state. This gas entry is used during the half rotation of the crankshaft, that is, 180° before starting the combustion cycles.

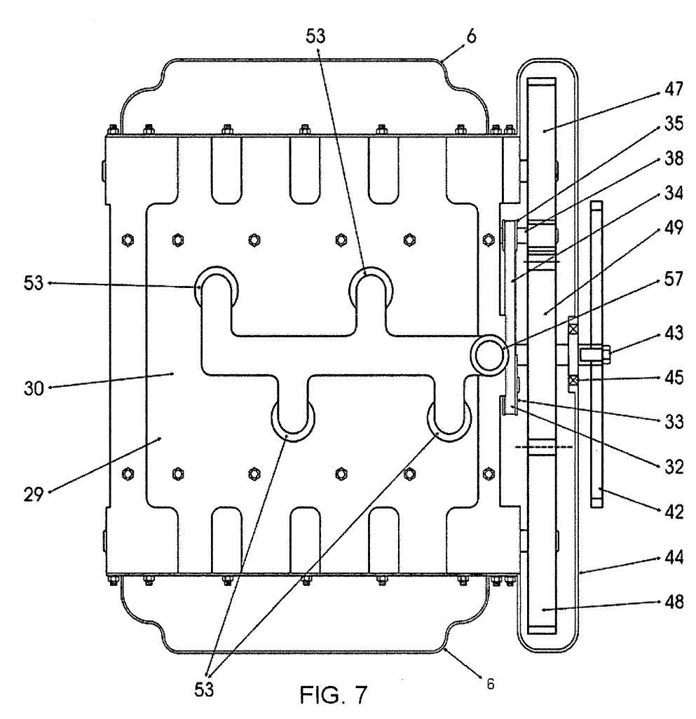

FIG. 7 is a lower engine (64) view, using the symmetrical chambers (1) of the present invention, wherein the same exemplary four-cylinder engine (64) is seen. Likewise, four multiple exhaust means (53) which are alternating is seen, in view of the exemplary four cylinder engine (64). The base (29) of the chamber (1) may be seen in the figure.

The crankshafts (40) may have a different number of crankpins (12), connecting rods (13) and bed plates (19), depending on the cylinder (4) quantity that the engine (64) has. The angular amplitude relation between the crankpins (12) varies depending on the engine (64), for example, in the four cylinder engine (64) of the figures, angular amplitude between connecting rod (13) crankpins (12) must be between 90°. Taking into account the ignition order of the chambers (1), the angular amplitude between connecting rod (13) crankpins (12) of the second cylinder (4) with respect to the third cylinder (4) crankpins (12) must be 180°, whereas the third cylinder (4) crankpins (12) with regards to the fourth cylinder (4) crankpins (12) must be 90°.

The reference points to define the piston (16) alternating movements within the cylinder (4), with reference to the position which will occupy in the interior of the combustion chamber, should be as follows: in CDC and LDC states, for example in FIG. 3, the found pistons (16) of the first cylinder (4) in the left end, is found in a LDC state, whereas the two found pistons (16) in the fourth cylinder in the right end, are found in a CDC state. The other four pistons (16) of the second and third cylinder (4) respectively, in the second cylinder (4) in the compression run sense and in the third cylinder (4), at 180° of the second cylinder (4) in the power run sense.

The chamber (1) symmetry appreciated in FIG. 1, which may correspond to different engines (64) of N number of cylinders (4), will have a different angular amplitude between the crankshaft (13) crankpins (12), depending on the number of engine (64) cylinders (4). That is, for example, a two cylinder (4) engine has an angular amplitude between the crankshaft (13) crankpins (12) of approximately 180°, whereas a three-cylinder (4) engine (64) has an angular amplitude between the crankshaft (13) crankpins (12) of approximately 120°; a five cylinder (4) engine (64) has an angular amplitude between the crankshaft (13) crankpins (12) of approximately 72°; and a six cylinder (4) engine (64) has an angular amplitude between crankshaft (13) crankpins (12) of 60°.

The combustion cycle for each combustion chamber (1) is of two-strokes, comprising the two afore-mentioned CDC and LDC points. In a LDC state the first cylinder (4) pistons (16) allow the pressurized gas admission, wherein the gas if fresh and clean, through the admission ports (62) which are uncovered, causing the gas sweep in the chamber (1) interior until being expelled by the exhaust ports (63). In a following manner, the two pistons (16) start, in a simultaneous manner, to move towards a CDC state, this movement causing the confined gas compression between the two pistons (16) and wet liner (20). In view of the gas compression, the gas starts to heat. The gas temperature tends to elevate, since with the present disposition, the volumes are added between the two pistons (16), which reach the CDC state, wherein in that moment, atomized fuel is introduced by the injector (25), which is inflamed by auto-ignition causing the necessary mechanical power to simultaneously push the two pistons (16) again to the LDC state. When the pistons (16) uncover again the admission ports (62), highly pressurized fresh and clean gas is again let inside, which is supplied by the blower (2).

The pump injection (5) synchronization and the gas pressure supplied by the blower (2), and the alternating movements of the two pistons (16), is due to the crankshaft two gears (47, 48) distribution, which are geared with the central synchronization gear (49), while the movement inertia is accumulated in the inertia wheel (42). That is, the gas sweeping synchronization in the combustion chamber (1) interior, is due to the crankshaft (40) gear (47, 48) synchronization, as well as the central synchronization gear (49). The gears (47, 48, 49) depend upon the engine (64) ignition order, which depending upon the cylinder (4) number of the engine (64) may have the following synchronization:

for two cylinder (4) engines: 1, 2, 1;

for three cylinder (4) engines: 1, 3, 2, 1;

for four cylinder (4) engines: 1, 3, 4, 2, 1;

for five cylinder (4) engines: 1, 4, 2, 5, 3, 1; and

for six cylinder (4) engines: 1, 5, 3, 6, 2, 4, 1.

The chamber cooling system is due to the wet liner (20) which surrounded by three water chambers (50), which re-circulate within these sectioned cavities by the plurality of seals (22, 23, 24). The water is driven in a current form by the water pump (5), which interchanges the heat towards the exterior radiator (not shown). Also, as part of the piston (16) cooling system, an oil sprayer (not shown) is included in the connecting rod (13) end, which humidifies the interior of the piston (16) housing.

Additionally, when fresh and clean gas is introduced to the cylinder (4) interior between each of the pistons (16), the wet liner (20) temperature decreases in view of the minor temperature of the fresh and clean gas.

To create a temperature balance in the cylinders (4), the admission ports (62) and the exhaust ports (63) of the air galleys (21) in the cylinders (4) are alternated. That is, while in the first cylinder (4) the admission ports (62) and the exhaust ports (63) are working as admission ports and exhaust port respectively, in the second cylinder (4) the admission ports (62) and the exhaust ports (63) are working the other way around, that is, the admission ports (62) as exhaust ports, whereas the exhaust ports (63) are working the other way around, the exhaust ports (63) as admission ports (62). When alternating the ports (62, 63), the cylinder (4) admission means (52) and exhaust means (53) are also alternated. By means of this alternating distribution of the means (52, 53) and ports (62, 63), heat is kept distributed, which irradiates to the environment by conversion, when having the bi-block cap (26) surface area exposed.

Alterations of the disclosed structure in the present, may be seen by those skilled in the art. However, it must be understood that the present description is related to the preferred embodiments of the invention, which is only for illustrative purposes and must not be construed as a limitation of the invention. All the embodiments that do not depart from the spirit of the invention will be included within the following claim breadth.

1. A two-stroke engine to be cooled by air, comprising:
a cap and base forming a cylinder chamber;
at least two cylinders having a wet liner, wherein said cylinders are housed in the cylinder chamber, wherein in said wet liner at least an admission port and at least an exhaust port are found;
a pair of found pistons within each cylinder, the pistons being adapted to move between a first position where the pistons are spaced and a second position where the pistons are proximate;
at least one admission mean per cylinder connected to said cap, which admits gas to the cylinder interior by means of the admission port;
at least one exhaust mean per cylinder connected to said base, which allows gas exhaust from the cylinder interior by means of the exhaust port; and
wherein said admission ports and said exhaust ports and the corresponding admission means and exhaust means alternate positions from one cylinder to another adjacent cylinder, so that in the adjacent cylinder the admission ports work as exhaust ports and the exhaust ports as admission ports and vice-versa for the next cylinder.

2. The engine according to claim 1, wherein said admission means are coupled to a gas inlet with a blower or compressor which introduces the gas to the interior of each cylinder, wherein the blower has at least a pair of helicoidal trilobular rotors, wherein said compressor is capable of introducing pressurized gas with greater temperature to the cylinder interior, transported to said gas inlet.

3. The engine according to claim 1, wherein said exhaust means give exit to interchanged gas by means of an engine exhaust mouth.

4. The engine according to claim 1, wherein said admission ports and said exhaust ports are distributed in an opposed manner between themselves throughout the wet liner radius, forming an air galley in the cylinder chamber.

5. The engine according to claim 1, wherein said admission ports are aligned with the admission means and said exhaust ports are aligned with said exhaust means.

6. The engine according to claim 1, wherein said admission means are aligned with said exhaust means and said exhaust ports are aligned with said admission means.

7. The engine according to claim 1, wherein the engine additionally comprises at least one shaft, at least one crankshaft, at least one crankpin, at least one connecting rod bolt and at least one connecting rod, wherein said connecting rod contains an internal lubrication vain capable of lubricating said bolt, and wherein said connecting rod additionally comprises a nozzle in one end, wherein the nozzle is capable of spraying oil to the piston to constantly cool said piston.

8. The engine according to claim 1, wherein said engine additionally comprises a plurality of seals in the wet liner exterior diameter, separating said ports from the oil section of oil tubs, said ports from a water chamber and said oil section from said water chamber.

9. The engine according to claim 1, wherein the engine is a two cylinder engine, wherein said engine has an angular amplitude of 180° between the connecting rod crankpins and wherein engine gears have an ignition order of 1, 2, 1.

10. The engine according to claim 1, wherein said engine is a three cylinder engine, wherein said engine has an angular amplitude of 120° between the connecting rods crankpins and wherein engine gears have an ignition order of 1, 3, 2, 1.

11. The engine according to claim 1, wherein said engine is a four cylinder engine, wherein said engine has an angular amplitude of 90° between the connecting rods crankpins and wherein engine gears have an ignition order of 1, 3, 4, 2, 1.

12. The engine according to claim 1, wherein said engine is a five cylinder engine, wherein said engine has an angular amplitude of 72° between the connecting rods crankpins and wherein engine gears have an ignition order of 1, 4, 2, 5, 3, 1.

13. The engine according to claim 1, wherein said engine is a six cylinder engine, wherein said engine has an angular amplitude of 60° between the connecting rods crankpins and wherein engine gears have an ignition order of 1, 5, 3, 6, 2, 4, 1.

14. The engine according to claim 1, wherein the wet liner is interchangeable, wherein said admission means comprise at least one injector and a check valve in said injector.
